(19) United States
(12) Patent Application Publication
(10) Pub. No.: US 2002/0054937 A1
(43) Pub. Date: May 9, 2002

(54) Flavoring system

(76) Inventor: Peter Daniel Berger, Los Angeles, CA (US)

Correspondence Address: Matthew J. Peirce, Esq., 1550 Starlight Canyon Avenue, Las Vegas, NV, 89123, US

(21) Appl. No.: 10/008,669

(22) Filed: Nov. 3, 2001

Related U.S. Application Data
(60) Provisional application No. 60/245,273, filed on Nov. 3, 2000.

(51) Int. Cl. A21D 10/02; B65D 85/00

(52) U.S. Cl. 426/106; 426/112; 426/115

(57) ABSTRACT

A new and improved flavoring system is disclosed that would be used to add to all manner of food items such as coffee, tea, soft drinks, other types of beverages, and deserts. The flavoring system would come in individual packets and would preferably come in liquid form. The liquids used with the present invention would preferably have flavors of many different varieties, such as orange, strawberry, cherry, and many other common fruit flavors. In addition, the flavors of the present invention would not necessarily be limited to fruity flavors, but could encompass other flavors as well, such as French vanilla, hazelnut, cinnamon, mint, chocolate, amaretto, and mocha, or other related flavorings.

### BACKGROUND OF THE INVENTION

The present invention concerns that of a new and improved flavoring system that would be used to add to all manner of food items such as coffee, tea, soft drinks, other types of beverages, and desserts.

### DESCRIPTION OF THE PRIOR ART

U.S. Pat. No. 5,906,845, issued to Robertson, discloses methods and devices for flavoring liquids.

U.S. Pat. No. 5,620,707, issued to Sanker et al., discloses a beadlet suitable for flavoring a beverage comprising a shell material and core composition suitable for ingesting.

U.S. Pat. No. 5,433,962, issued to Stipp, discloses a flavored instant coffee product comprising a creamer base, a sweetener base, and a flavor base.

### SUMMARY OF THE INVENTION

The present invention concerns that of a new and improved flavoring system that would be used to add to all manner of food items such as coffee, tea, soft drinks, other types of beverages, and desserts. The flavoring system would come in individual packets and would preferably come in liquid form. The liquids used with the present invention would preferably have flavors of many different varieties, such as orange, strawberry, cherry, and many other common fruit flavors. In addition, the flavors of the present invention would not necessarily be limited to fruity flavors, but could encompass seasonings such as French vanilla, hazelnut, cinnamon, mint, chocolate, amaretto, and mocha, or other related flavorings.

There has thus been outlined, rather broadly, the more important features of a flavor system and additive in order that the detailed description thereof that follows may be better understood and in order that the present contribution to the art may be better appreciated. There are, of course, additional features of the flavor system and additive that will be described hereinafter and which will form the subject matter of the claims appended hereto.

In this respect, before explaining at least one embodiment of the flavor system and additive in detail, it is to be understood that the flavor system and additive is not limited in its application to the details of construction and to the arrangements of the components set forth in the following description or illustrated in the drawings. The flavor system and additive is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present flavor system and additive. It is important, therefore, that the claims be regard as including such equivalent constructions insofar as they do not depart from the spirit and scope of the present invention.

It is therefore an object of the present invention to provide a flavor system and additive which has all of the advantages of the prior art and none of the disadvantages.

It is another object of the present invention to provide a flavor system and additive which may be easily and efficiently manufactured and marketed.

It is another object of the present invention to provide a flavor system and additive which is of durable and reliable construction.

It is yet another object of the present invention to provide a flavor system and additive which is economically affordable and available for relevant purchasing government entities.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows one possible method of packaging of the present invention.

FIG. 2 shows some possible beverages the flavoring system of the present invention could be used with.

### DESCRIPTION OF THE PREFERRED EMBODIMENT

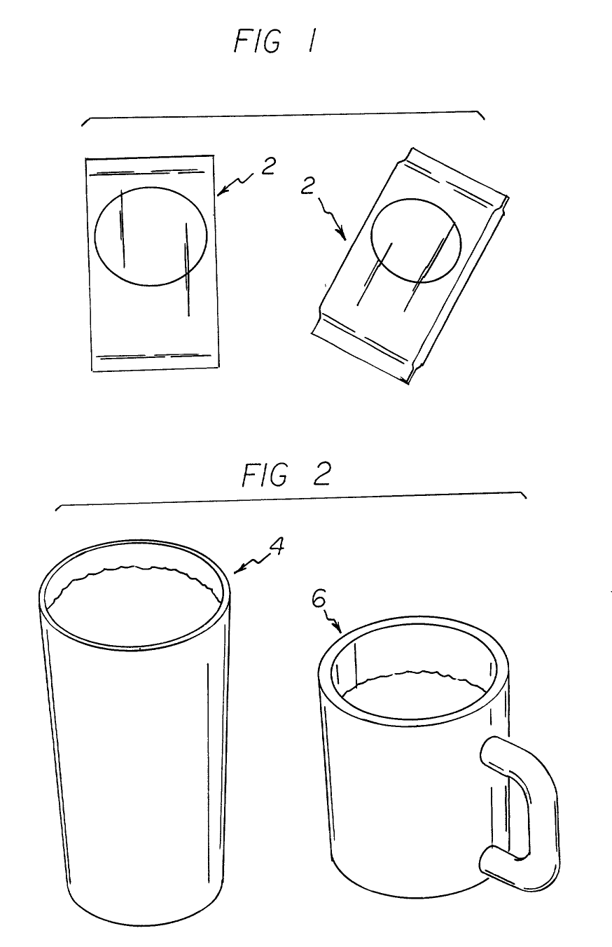

FIG. 1 shows one possible method of packaging of the present invention. Preferably, the flavoring system of the present invention would come in small flavor packets 2 which could be easily transported and stored virtually anywhere. The flavoring system of the present invention would be used to add to all manner of food items such as coffee, tea, soft drinks, other types of beverages, and desserts. The flavoring system would preferably come in liquid form. The liquid used with the present invention would preferably have flavors of many different varieties, such as orange, strawberry, cherry, and many other common fruit flavors. In addition, the flavors of the present invention would not necessarily be limited to fruity flavors, but could encompass other flavors as well. Some of the other flavors could include French vanilla, hazelnut, cinnamon, mint, chocolate, amaretto, and mocha, or other related flavorings.

Each packet would preferably be two and one-half inches in length, one and one-half inches in width, and one-sixteenth of an inch in depth. Each package would preferably be fabricated from foil paper.

FIG. 2 shows some possible beverages the flavoring system of the present invention could be used with. The flavoring system of the present invention could be used with tea 4 or coffee 6. In addition, a user could use the flavoring system of the present invention with many other types of beverages, such as alcoholic drinks, soft drinks, seltzer water, regular drinking water, or just about any other type of drink in which a user would want to change the flavor.

What I claim as my invention is:

1. A food additive storage apparatus comprising:
(a) a package for storing flavor additives for food, the package preferably being two and one-half inches in length, one and one-half inches in width, and one-sixteenth of an inch in depth, the package preferably being fabricated from foil paper, and
(b) a quantity of liquid flavor additive located within the package for storing flavor additives for food.

2. A food additive storage apparatus according to claim 1 wherein the quantity of liquid flavor additive located within the package for storing flavor additives for food would amount to one-half teaspoon.

3. A food additive storage apparatus according to claim 1 wherein the quantity of liquid flavor additive located within the package for storing flavor additives for food would amount to one-fourth teaspoon.

4. A food additive storage apparatus according to claim 1 wherein the quantity of liquid flavor additive located within the package for storing flavor additives for food would have a fruit flavor.

5. A food additive storage apparatus according to claim 4 wherein the quantity of liquid flavor additive located within the package for storing flavor additives for food would have a flavor selected from the group consisting of orange, strawberry, raspberry, cherry, and lemon.

6. A food additive storage apparatus according to claim 1 wherein the quantity of liquid flavor additive located within the package for storing flavor additives for food would have a flavor selected from the group consisting of French vanilla, hazelnut, cinnamon, mint, chocolate, amaretto, and mocha.

7. A food additive storage apparatus according to claim 1 wherein the quantity of liquid flavor additive located within the package for storing flavor additives for food would preferably be used in combination with coffee or tea.
